(19) United States
(12) Patent Application Publication
(10) Pub. No.: US 2025/0055236 A1
(43) Pub. Date: Feb. 13, 2025

(54) PLUG CONNECTOR PART FOR A CHARGING SYSTEM FOR CHARGING AN ELECTRIC VEHICLE

(71) Applicant: Phoenix Contact E-Mobility GmbH, Schieder-Schwalenberg (DE)

(72) Inventors: Cedric DEPPE, Doerentrup (DE); Carsten GARTH, Lemgo (DE); Ralf FELDNER, Horn-Bad Meinberg (DE)

(21) Appl. No.: 18/797,569

(22) Filed: Aug. 8, 2024

(30) Foreign Application Priority Data
Aug. 11, 2023 (DE) 102023121606.6

(51) Int. Cl. H01R 13/66; B60L 53/16; H01R 13/502; H01R 13/52

(52) U.S. Cl. CPC H01R 13/6683; B60L 53/16; H01R 13/502; H01R 13/5202

(57) ABSTRACT

A plug-in connector part for a charging system for charging an electric vehicle includes: a first housing part forming a plug-in portion for plugging into a mating plug-in connector part; a second housing part connected to the first housing part; at least one plug-in contact, arranged on the first housing part, for electrical contact with a mating contact element of the mating plug-in connector part; a sealing element having a first sealing portion for sealing a transition between the first housing part and the second housing part moisture-tight; and a temperature sensor assembly including a temperature sensor. The sealing element has a second sealing portion, connected to the first sealing portion, for moisture-tight sealing a transition between the first housing part and the at least one plug-in contact. The temperature sensor is arranged on the sealing element so as to measure heating at the at least one plug-in contact.

### CROSS-REFERENCE TO PRIOR APPLICATION

Priority is claimed to German Patent Application No. DE 10 2023 121 606.6, filed on Aug. 11, 2023, the entire disclosure of which is hereby incorporated by reference herein.

### FIELD

The invention relates to a plug connector part for a charging system for charging an electric vehicle, and to a charging system for charging an electric vehicle.

### BACKGROUND

Such a plug-in connector part comprises a first housing part which forms a plug-in portion for plug-in connection with a mating plug-in connector part. A second housing part is connected to the first housing part. On the first housing part, at least one plug-in contact is arranged for electrical contact with a mating contact element of the mating plug-in connector part. A sealing element has a first sealing portion which seals a transition between the first housing part and the second housing part moisture-tight. A temperature sensor assembly has a temperature sensor for measuring heating at the at least one plug-in contact.

Such a plug-in connector part can in particular be designed as a charging socket and be arranged on an electric vehicle. A mating plug-in connector part in the form of a charging plug arranged on a charging cable can be connected to such a charging socket in order in this way to establish an electrical connection between a charging station and the electric vehicle and to electrically charge the electric vehicle.

In the field of electromobility, it is desirable to charge electric vehicles quickly and efficiently in order to reduce charging times and associated trip interruption times. In order to enable rapid charging of an electric vehicle within the context of a rapid charging process, high charging capacities are used, combined with large charging currents—for example, with a current of 700 A or even higher.

The arrangement and dimensioning of electrical contact elements on plug-in connector parts for charging an electric vehicle are usually stipulated normatively. Contact geometries on such plug-in connector parts therefore cannot be easily scaled in order to possibly achieve a larger current-carrying capacity at the contact elements. One challenge is therefore to enable the greatest possible power transfer with existing contact geometries.

When large charging currents are transmitted, heating at the contact elements and other components of the plug-in connector part occurs. It is stipulated in this respect that heating at a plug-in connector part must not exceed 50 K. If large charging currents are used, care must therefore be taken to ensure that excess heating at the plug-in connector part does not occur.

For this reason, a plug-in connector part of the type in question is provided with a temperature monitoring system, for which heating at a particular plug-in contact is monitored by means of a temperature sensor assembly. Depending upon the heating at the plug-in contact. countermeasures can thereby be initiated as soon as the heating approaches a permissible limit or exceeds such a limit.

Typically, when excessive heating is detected during a charging process using a charging current in the form of an alternating current, a shutdown is initiated as a countermeasure, during which the charging current is switched off completely, and a charging process is accordingly terminated as soon as a permissible limit is exceeded. In contrast, during a charging process while using a charging current in the form of a direct current, the charging current is usually regulated down before reaching a permissible limit so that heating approaches the permissible limit, but does not exceed it. The more accurately a temperature measurement is carried out in this context, the more precisely the charging current can be regulated so that heating is limited to a permissible level, while still transmitting a maximum possible charging current within the context of permissible heating, and efficient charging of an electric vehicle is thereby enabled.

When measuring the temperature at a plug-in contact, it is desirable on the one hand for the temperature at the plug-in contact to be recorded as accurately as possible and with a short time delay. In addition, however, care must be taken so that a temperature sensor assembly is reliably electrically insulated from an associated plug-in contact, even at the typically high voltages in a charging system, so that a voltage flashover cannot occur between the plug-in contact and the temperature sensor assembly.

In a temperature detection device for a plug-in connector part known from DE 10 2020 126 192 A1, a latching element is arranged on a contact element. A sensor holder is arranged on the latching element, which attaches a temperature sensor to the latching element.

In a plug-in connector part known from EP 3 402 012 A1, a temperature sensor is connected to an associated plug-in contact via a heat-conducting element made of silicone.

### SUMMARY

In an embodiment, the present invention provides a plug-in connector part for a charging system for charging an electric vehicle, comprising: a first housing part forming a plug-in portion for plugging into a mating plug-in connector part; a second housing part connected to the first housing part; at least one plug-in contact, arranged on the first housing part, configured for electrical contact with a mating contact element of the mating plug-in connector part; a sealing element having a first sealing portion configured to seal a transition between the first housing part and the second housing part moisture-tight; and a temperature sensor assembly comprising a temperature sensor, wherein the sealing element has a second sealing portion, connected to the first sealing portion, configured to moisture-tight seal a transition between the first housing part and the at least one plug-in contact, and wherein the temperature sensor is arranged on the sealing element so as to measure heating at the at least one plug-in contact.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a charging station having a charging cable arranged thereon for connecting to an electric vehicle;

FIG. 2 is a view of a plug-in connector part in the form of a charging plug;

FIG. 3 is a view of an exemplary embodiment of a plug-in connector part in the form of a charging socket on an electric vehicle;

FIG. 4 is another view of the plug-in connector part;

FIG. 5 is a view of an exemplary embodiment of a housing part of a plug-in connector part;

FIG. 6 is a sectional view along the line B-B according to FIG. 5;

FIG. 7 is a sectional view along the line A-A according to FIG. 6;

FIG. 8 is a sectional view along the line C-C according to FIG. 7;

FIG. 9 is a sectional view of an exemplary embodiment of a housing part with a plug-in contact arranged thereon; and

FIG. 10 is a sectional view of another exemplary embodiment of a housing part with a plug-in contact arranged thereon.

### DETAILED DESCRIPTION

In an embodiment, the present invention provides a plug-in connector part which enables reliable temperature measurement with reliable electrical insulation between a temperature sensor element and an associated plug-in contact.

Accordingly, the sealing element has a second sealing portion, connected to the first sealing portion, which seals a transition between the first housing part and the at least one plug-in contact moisture-tight. The temperature sensor is arranged on the sealing element in order to measure heating at the at least one plug-in contact.

The plug-in connector part is designed for use in a charging system for charging an electric vehicle. The plug-in connector part can, for example, be formed by a charging socket which is arranged on the electric vehicle and can be plugged into an associated mating plug-in connector part in the form of a charging plug on a charging cable coupled to a charging station.

The plug-in connector part has a housing which comprises two housing parts which are attached to one another and which accommodate components of the plug-in connector part in their interior—for example, connection components for connecting plug-in contacts to associated electrical connecting lines or control components such as circuit boards or the like. The housing parts therefore form an interior space which must be sealed to the outside in order to prevent moisture from the outside of the plug-in connector part from penetrating into the interior of the housing of the plug-in connector part during operation.

To seal a transition between the first housing part and the second housing part, a sealing element is provided which is arranged with a first sealing portion between the first housing part and the second housing part in such a way that moisture cannot penetrate between the first housing part and the second housing part into the interior of the plug-in connector part.

In addition, the sealing element also serves to seal moisture-tight a transition between the first housing part and the at least one plug-in contact. For this purpose, the sealing element has a second sealing portion which occupies an intermediate position between a portion of the first housing part and the at least one plug-in contact and thereby seals a transition between the plug-in contact and the first housing part. The at least one plug-in contact can therefore extend through the first housing part. e.g., into the region of a plug-in portion formed on the first housing part, so that the at least one plug-in contact can be plugged into an associated mating contact element of the mating plug-in connector part in order to connect the plug-in connector part to the mating plug-in connector part. By means of the second sealing portion, it is thereby prevented that moisture can enter the interior of the plug-in connector part from the region of the plug face formed by the at least one plug-in contact on the plug-in connector part.

The sealing element with the first sealing portion and the second sealing portion is preferably formed integrally and in one piece from a contiguous part. In any case, the first sealing portion and the second sealing portion are connected to each other so that the first sealing portion and the second sealing portion are contiguous. The result is a sealing element that can be easily mounted to provide the sealing effect between the housing parts.

The sealing element assumes a sealing function by means of the first sealing portion and the second sealing portion in order to seal from the outside an inner space of the housing formed by the first housing part and the second housing part. In addition, a temperature-conducting connection is established between the temperature sensor assembly and the at least one plug-in contact via the sealing element in that the temperature sensor of the temperature sensor assembly is arranged on the sealing element and therefore absorbs heat at the at least one plug-in contact via the sealing element. The sealing element therefore also serves to conduct heat from the at least one plug-in contact, on which the sealing element rests for sealing, to the temperature sensor assembly, so that heat can be absorbed and measured at the temperature sensor of the temperature sensor assembly.

In one embodiment, the sealing element is made of a soft elastic material, in particular a rubber material or a silicone material. The sealing element can, for example, be made of a conventional silicone material—for example, a conventional sealing silicone.

Advantageously, the silicone material can have an increased temperature resistance—for example, greater than 200° C., preferably greater than 500° C.

In one embodiment, the sealing element is made of an elastic plastic material, e.g., a silicone material, containing a ceramic filler. By using a ceramic filler, the thermal conductivity of the elastic plastic material can be increased, with simultaneously good electrical insulation. The thermal conductivity can, for example, be greater than 1.5 W/mK—for example, greater than 2.0 W/mK, preferably greater than 3.0 W/mK, more preferably greater than 5.0 W/mK.

Aluminum oxide, aluminum nitrite, or boron nitrite, for example, can be used as a ceramic filler, which is added to the silicone base material in particle form.

A silicone material in the form of a heat-conducting silicone rubber composition is described, for example, in EP 1 331 248 B1 and can be used for the sealing element.

In one embodiment, the first sealing portion is arranged between a first edge portion of the first housing part and a second edge portion of the second housing part and thereby seals moisture-tight the transition between the first housing part and the second housing part. The housing parts are preferably attached to one another via their edge portions in such a way that the first sealing portion of the sealing element occupies an intermediate position between the first edge portion and the second edge portion and therefore seals moisture-tight a transition between the first edge portion and the second edge portion. Moisture therefore cannot penetrate between the first edge portion and the second edge portion into the interior of an inner space, enclosed by the first housing part and the second housing part, of a housing of the plug-in connector part.

In one embodiment, the first sealing portion extends along an extension line along which the first edge portion and the second edge portion are attached to one another with interposition of the first sealing portion. The first sealing portion in this case is preferably circumferentially closed along the extension line, so that the sealing portion forms a circumferentially closed ring which seals moisture-tight a transition between the edge portions of the housing parts along the extension line. The circumferentially closed, first sealing portion therefore follows the extension line along which the edge portions of the housing parts are attached to one another and thereby occupies an intermediate position between the edge portions of the housing parts. By connecting the housing parts to one another, the first sealing portion is preferably compressed at least to a certain degree, so that a sealing effect of the first sealing portion is reliably established between the edge portions of the housing parts.

In one embodiment, the at least one plug-in contact has a shaft portion, extending along a longitudinal axis, around which the second sealing portion extends. The shaft portion can, for example, have a cylindrical shape whose cylinder axis extends along the longitudinal axis. The second sealing portion surrounds the shaft portion and thereby occupies an intermediate position between the shaft portion and the first housing part so that a transition between the shaft portion and the first housing part is sealed by the second sealing portion of the sealing element.

In one embodiment, the at least one plug-in contact extends along the longitudinal axis through the first housing part. In particular, the at least one plug-in contact can extend from an inner space, enclosed by the first housing part and the second housing part, of a housing of the plug-in connector part through the first housing part to the outside, e.g., into the region of a plug-in portion formed on the first housing part, so that, in order to plug the plug-in connector part into the associated mating plug-in connector part, the at least one plug-in contact on the outside of the first housing part can be brought into a plug-in, electrically contacting connection with an associated mating contact of the mating plug-in connector part. In this case, the second sealing portion prevents moisture from being able to penetrate into the interior of the housing of the plug-in connector part between the plug-in contact and the first housing part.

In one embodiment, the at least one plug-in contact is accommodated in a receiving dome formed on the first housing part. The second sealing portion is arranged, viewed radially to the longitudinal axis, between the shaft portion and the receiving dome. The receiving dome can in particular have the shape of a cylindrical sleeve which extends around the shaft portion of the plug-in contact. The second sealing portion in this case occupies an intermediate position between the shaft portion and the receiving dome, so that the second sealing portion is arranged, viewed radially to the longitudinal axis, between the shaft portion and the receiving dome. The second sealing portion therefore acts as a radial seal in that the second sealing portion circumferentially surrounds the shaft portion of the associated plug-in contact and also lies in the receiving dome of the first housing part. The second sealing portion in this case is preferably compressed to a certain degree so that a transition between the receiving dome and the shaft portion is reliably sealed via the second sealing portion.

The plug-in connector part can, for example, have a plurality of plug-in contacts—for example, two plug-in contacts for transmitting a charging current in the form of a direct current. Each plug-in contact is assigned in this case a second sealing portion which is connected in each case to the first sealing portion of the sealing element. Each plug-in contact can (also) be assigned in this case a temperature sensor assembly with a temperature sensor so that the temperature can be measured at each plug-in contact.

In one embodiment, the second sealing portion is connected to the first sealing portion via a connecting portion. The first sealing portion and the second sealing portion are preferably formed integrally and in one piece together with the connecting portion, so that a contiguous, integral sealing element is created.

The connecting portion can, for example, have the shape of a web which connects the preferably circumferentially closed first sealing portion located radially outside the second sealing portion to the second sealing portion.

For example, the sealing element can have a plurality of connecting portions, wherein each second sealing portion is connected to the outer, circumferential first sealing portion via one or more connecting portions. For example, each plug-in contact can be assigned a second sealing portion which is connected to the first sealing portion via one or more connecting portions.

The first sealing portion, the second sealing portion, and the connecting portion can be formed from the same material or from different materials—for example, using a two-component, plastic injection-molding technique.

In one embodiment, the temperature sensor is arranged in the region of the second sealing portion on the sealing element in order to measure heating at the at least one plug-in contact. If the plug-in connector part has a plurality of plug-in contacts, and each plug-in contact is assigned a second sealing portion for sealing a transition between the particular plug-in contact and the first housing part, a temperature sensor can be arranged in the region of each second sealing portion in order to be able to record the temperature at each plug-in contact.

For example, the sealing element has a temperature sensing portion, connected to the second sealing portion, on which the temperature sensor is arranged. The temperature sensing portion protrudes radially from the second sealing portion, for example, in that the temperature sensing portion is formed from the material of the sealing element onto the second sealing portion—for example, in the form of a radially outward-projecting tab on the second sealing portion. The temperature sensor is arranged on the temperature sensing portion and, via the temperature sensing portion, can therefore measure heating at the plug-in contact assigned to the second sealing portion.

In one embodiment, the temperature sensor is embedded in the material of the sealing element. For example, the temperature sensor can be overmolded by the material of the sealing element during production of the sealing element. In another embodiment, the temperature sensor can be inserted into a preformed cavity on the sealing element after manufacturing the sealing element—for example, by injection molding. When in a normal operating state, the temperature sensor is embedded in the sealing element in such a way that heat can be conducted to the temperature sensor via the sealing element and absorbed by the temperature sensor.

One or more sensor lines can extend through the material of the sealing element to the temperature sensor.

In one embodiment, the temperature sensor is arranged on a circuit board which rests on the sealing element. The temperature sensor can, for example, be designed as a so-called SMD component arranged on the circuit board and connected to the circuit board by a solder connection (SMD: surface mounted device).

The electrical connection of the temperature sensor can be made via the circuit board, e.g., to connect the temperature sensor to a control element—for example, a microcontroller.

The circuit board can, for example, rest in the axial direction on the sealing element—for example, on the associated second sealing portion or the temperature sensing portion. In another embodiment, the circuit board can rest in the radial direction on the sealing element—for example, on the associated second sealing portion or the temperature sensing portion.

In one embodiment, the plug-in contact comprises a contact portion for establishing an electrically contacting plug-in connection to an associated mating contact element of a mating plug-in connector part. The contact portion can, for example, have the shape of a contact pin or the shape of a contact socket. The mating contact element is correspondingly complementary in shape and has the shape of a contact socket or a contact pin. When the plug-in connector part is connected to the mating plug-in connector part, the plug-in contact is connected in a plug-in manner to the associated mating contact element via the contact portion so that an electrical connection is established.

The plug-in connector part comprises one or more plug-in contacts which, when the plug-in connector part is connected in a plug-in manner to an associated mating plug-in connector part, come into plug-in engagement with a respectively associated mating contact element of the mating plug-in connector part and thus establish an electrical contact between the plug-in connector part and the mating plug-in connector part. The plug-in contacts can, for example, each be designed to transmit a charging current in the form of a direct current.

A charging system for charging an electric vehicle includes a plug-in connector part of the type described above. Such a charging system also includes a mating plug-in connector part that can be plugged into the plug-in connector part. The plug-in connector part may, for example, be arranged as a charging socket on the electric vehicle. In contrast, the mating plug connector part can be formed as a charging socket on the electric vehicle, for example, which is arranged on a charging cable and can be connected to the plug connector part in the form of the charging plug. The charging plug can, for example, be connected to a charging station via the charging cable so that charging currents can be transmitted from the charging station to the electric vehicle when the plug connector part and the mating plug connector part are in the connected position.

A plug connector part of the type described here can in particular be used for transmitting charging currents in the form of direct currents. However, such a plug connector part can also serve to transmit charging currents in the form of alternating currents.

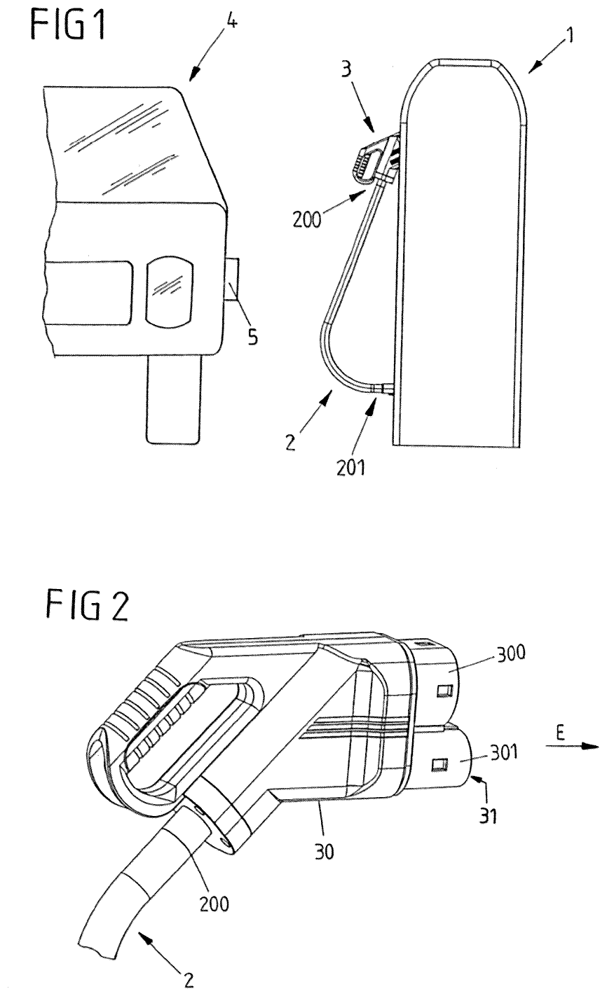

FIG. 1 shows a charging system comprising a charging station 1 which is used to charge an electrically powered vehicle 4, also referred to as an electric vehicle. The charging station 1 is designed to provide a charging current in the form of an alternating current or a direct current and has a cable 2 that is connected at one end 201 to the charging station 1 and at another end 200 to a mating plug connector part 3 in the form of a charging plug.

As can be seen from FIG. 2, in one exemplary embodiment, the mating plug-in connector part 3 has plug-in portions 300, 301 on a housing 30, with which the mating plug-in connector part 3 can be plugged into engagement with an associated plug-in connector part 5 in the form of a charging socket on the vehicle 4. In this way, the charging station 1 can be electrically connected to the vehicle 4 in order to transmit charging currents from the charging station 1 to the vehicle 4.

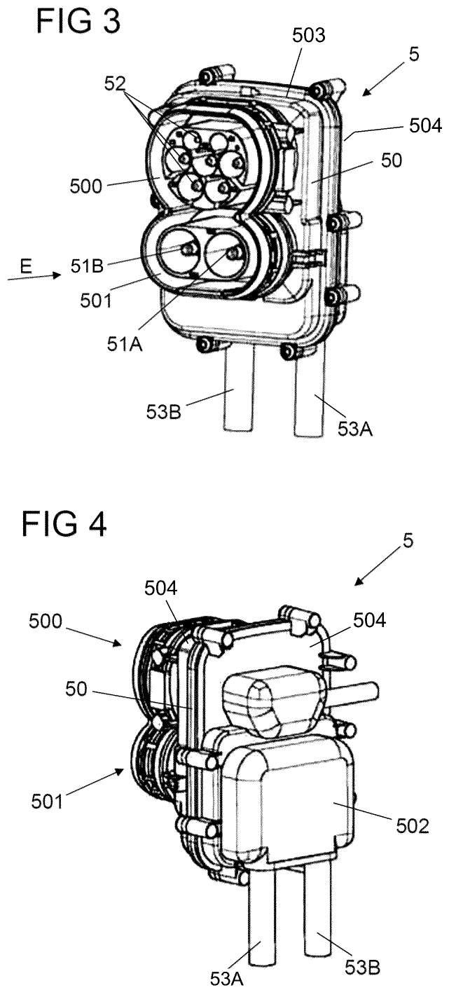

In an exemplary embodiment shown in FIGS. 3 and 4 of a plug-in connector part 5 in the form of a charging socket to be arranged on an electric vehicle 4, plug-in portions 500, 501 are formed on a housing 50 and can be connected along the plug-in direction E to the plug-in portions 300, 301 of the mating plug-in connector part 3 in the form of the charging plug in order in this way to establish a mechanical plug-in connection between the charging plug 3 and the charging socket 5.

Contact elements 52 for transmitting an alternating current and also control contacts are arranged on an upper plug-in portion 500 of the plug-in connector part 5 in the shown exemplary embodiment. In contrast, plug-in contacts 51A, 51B for transmitting a charging current in the form of a direct current are arranged on a lower plug-in portion 501.

The plug-in contacts 51A, 51B can, for example, be designed as pin contacts and, when the plug-in connector part 5 in the form of the charging socket is connected in a plug-in manner to the mating plug-in connector part 3 in the form of the charging plug, come into electrical engagement with associated mating contact elements 31 on the plug-in portion 301 so that an electrical connection is established between the plug-in connector part 5 and the mating plug-in connector part 3.

The plug-in contacts 51A, 51B are each connected to a load line 53A, 53B, which is inserted into the housing 50 and laid within the electric vehicle 4 for the purpose of carrying the charging current.

In order to make fast charging of the electric vehicle 4 possible, for example within the framework of a so-called rapid charging process, the transmitted charging currents have a high current intensity—for example, higher than 500 A, possibly even on the order of magnitude of 700 A or more. As a result of such high charging currents, thermal losses occur at the cable 2 and also at the charging plug 3, as well as at the charging socket 5, which thermal losses lead to heating of the cable 2, of the charging plug 3, and of the charging socket 5.

Permissible heating at components of the charging system is limited normatively—for example, to a maximum value of 50 K. It follows that measures must be taken to prevent excessive heating during charging operation, in particular if high current intensities, e.g., on the order of magnitude of 700 A or more, are used.

In the illustrated exemplary embodiment, the housing 50 is composed of two housing parts 503, 504 which are attached to one another and together enclose in their interior an inner space within which the plug-in contacts 51A, 51B, 52 are connected to the associated electrical lines, and within which functional components of the plug-in connector part 5, e.g., control components on circuit boards, are accommodated. This inner space is sealed moisture-tight to prevent moisture from penetrating the plug-in connector part 5 and possibly impairing electrical insulation between electrical components of the plug-in connector part 5.

FIGS. 5 to 8 show an exemplary embodiment of a housing part 503 which, together with another housing part 504 to be attached thereto, forms the housing 50 of the plug-in connector part 5. The housing parts 503, 504 are assigned to one another by edge portions 508, 509 and are to be placed on one another in such a way that the housing parts 503, 504 are joined together in a moisture-tight manner and therefore together enclose an inner space of the housing 50 in their interior.

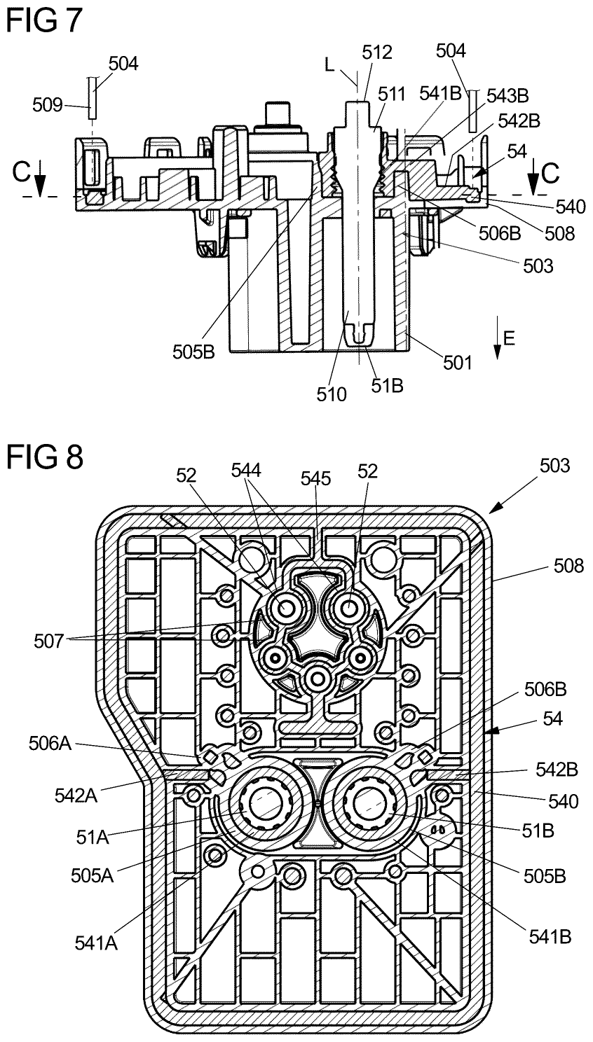

The edge portion 509 of the housing part 504 is drawn schematically in FIG. 7 and extends circumferentially on the housing part 504 such that the edge portion 509 can be placed on the circumferential edge portion 508 formed on the housing part 503.

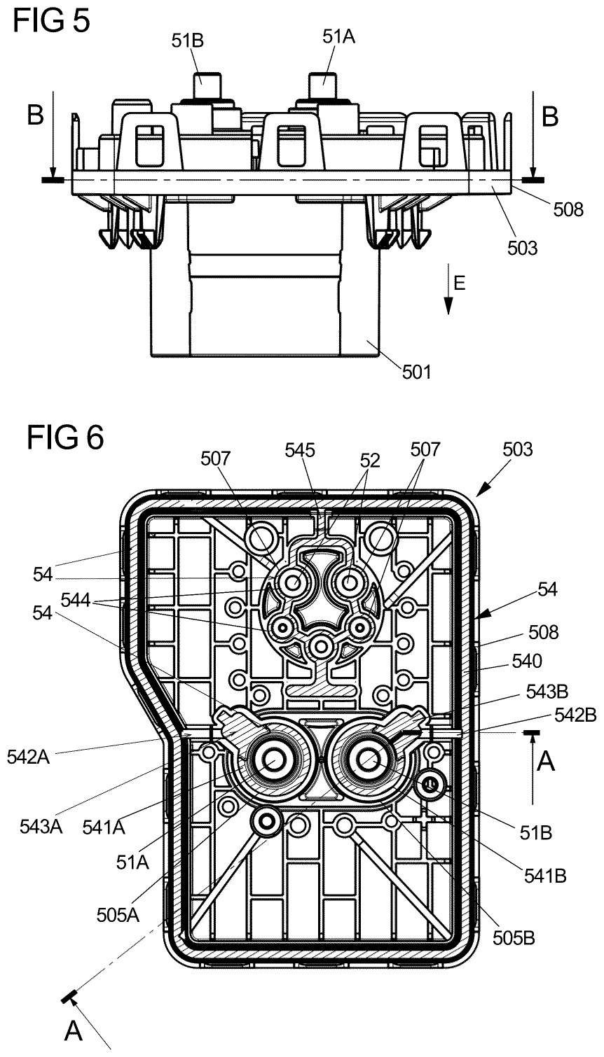

In order to seal a transition between the edge portions 508, 509 moisture-tight, a sealing element 54 is provided which has a first sealing portion 540 which extends along a circumferentially closed extension line and follows the edge portion 508, as can be seen from FIG. 6 and FIG. 8. In this way, the sealing portion 540 forms a circumferentially closed sealing contour which, in the assembled state of the plug-in connector part 5, comes to lie between the edge portions 508, 509 of the housing parts 503, 504, so that a transition between the edge portions 508, 509 is sealed moisture-tight by the sealing portion 540.

In the assembled state, the housing parts 503, 504 are fastened to one another—for example, via screw connections or latching connections. By connecting the housing parts 503, 504 to one another, the edge portion 509 of the housing part 504 rests against the sealing portion 540 of the sealing element 54, so that the sealing portion 540 occupies an intermediate position between the edge portions 508, 509 and is compressed to a certain degree in order to seal the transition between the edge portions 508, 509 moisture-tight.

The sealing element 54 preferably consists of a soft elastic plastic material—for example, a silicone material. The sealing element 54 is therefore elastically deformable and, to produce a sealing effect, compressible.

On the housing part 503, the plug-in portion 501 is formed, in the region of which the plug-in contacts 51A, 51B are arranged. For this purpose, the plug-in contacts 51A, 51B extend through the housing part 503 so that the plug-in contacts 51A, 51B each with a contact portion 510 lie in the plug-in portion 501 and point with an end 512 into the interior of the housing 50, as can be seen in particular from the sectional view according to FIG. 7. The particular plug-in contact 51A, 51B, 52 in the interior of the housing 50 is connected to an associated line via the end 512.

In addition, the plug-in contacts 52 in the region of the plug-in portion 500 also extend through the housing part 503.

In order to seal a transition between the particular plug-in contact 51A, 51B, 52 and the housing part 503 in a moisture-tight manner, the sealing element 54 has second sealing portions 541A, 541B, 544, which each extend circumferentially around a shaft portion 511 of the associated plug-in contact 51A, 51B, 52, as can be seen from FIG. 7. Each sealing portion 541A, 541B, 544 is received in an associated receiving dome 505A, 505B, 507, so that the sealing portion 541A, 541B, 544 is arranged radially between the associated plug-in contact 51A, 51B, 52, extending longitudinally along a longitudinal axis L, and the receiving dome 505A, 505B, 507 and therefore acts as a radial seal between the housing part 503 and the shaft portion 511 of each associated plug-in contact 51A, 51B, 52.

In the region of the shaft portion 511, the plug-in contact 51A, 51B, 52 is cylindrically shaped, wherein the cylinder axis corresponds to the longitudinal axis L of the particular plug-in contact 51A, 51B, 52. Accordingly, the associated receiving dome 505A, 505B, 507 on the housing part 53 is also cylindrically shaped. The sealing portion 541A, 541B, 544 surrounds the cylindrical shaft portion 511 circumferentially and occupies an intermediate position between the shaft portion 511 and the associated receiving dome 505A, 505B, 507, so that a transition between the particular plug-in contact 51A, 51B, 52 and the housing part 503 is sealed in a moisture-tight manner.

The second sealing portions 541A, 541B, 544 are part of the sealing element 54. The second sealing portions 541A, 541B, 544 are connected to the outer, circumferential first sealing portion 540 via connecting portions 542A, 542B, 545 in the form of webs so that an integral, coherent sealing element 54 is obtained, which can be arranged in a uniform manner for mounting the plug-in connector part 5 between the housing parts 503, 504 in order to mount the housing parts 503, 504 on one another.

In order to carry out temperature monitoring in particular on the plug-in contacts 51A, 51B designed to transmit a charging current in the form of a direct current, a temperature sensing portion 543A, 543B is formed on the second sealing portions 541A, 541B assigned to the plug-in contacts 51A, 51B, as can be seen from FIG. 6 in conjunction with FIG. 7. The temperature sensing portion 543A, 543B projects radially outwards from the particular sealing portion 541A, 541B and covers a housing portion 506A, 506B formed on the housing part 503.

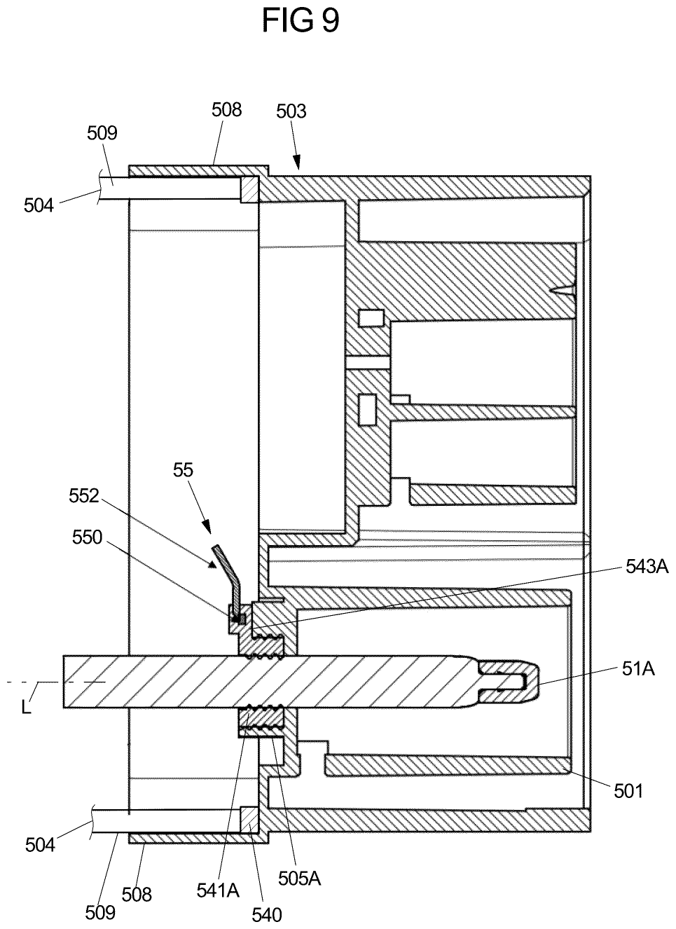

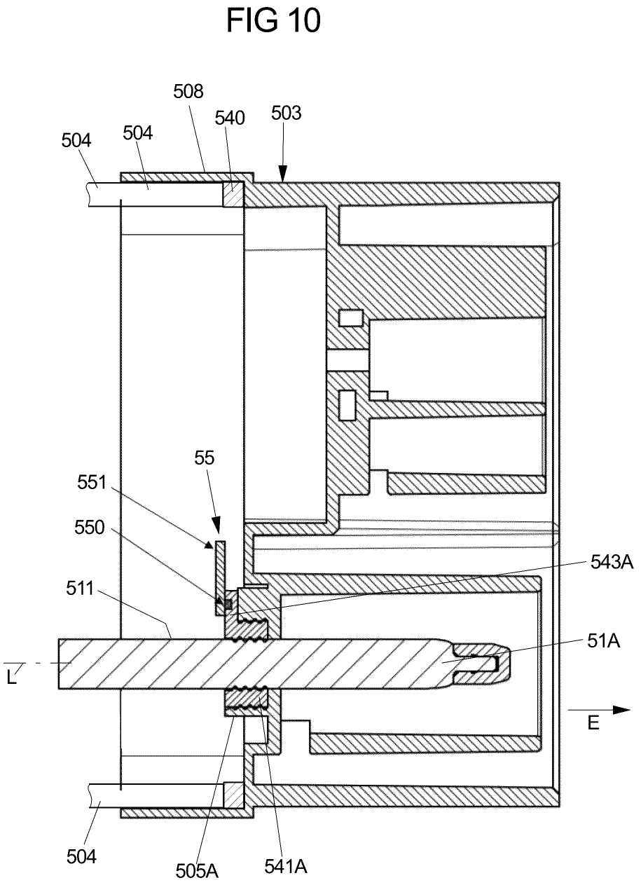

A temperature sensor assembly 55, shown in different exemplary embodiments in FIGS. 9 and 10, is arranged on the temperature sensing portion 543A, 543B, and has a temperature sensor 550 that is operatively connected to the material of the temperature sensing portion 543A, 543B such that heat can be introduced from the associated plug-in contact 51A, 51B via the sealing portion 541A, 541B and the temperature sensing portion 543A, 543B into the temperature sensor 550 and can be absorbed there for the purpose of temperature measurement.

In the exemplary embodiment according to FIG. 9, the temperature sensor 550 is arranged on a circuit board 552. The circuit board 552 serves as a carrier element for the temperature sensor 550, which is embedded in the material of the temperature sensing portion 543A, 543B. In the illustrated exemplary embodiment, the circuit board 552 rests in the axial direction (in relation to the longitudinal axis L of the associated plug-in contact 51A, 51B) on the temperature sensing portion 543A, 543B protruding radially from the associated sealing portion 541A, 541B.

In the exemplary embodiment according to FIG. 10, the temperature sensor 550 is embedded in the material of the associated temperature sensing portion 543A, 543B and is completely surrounded by the material of the temperature sensing portion 543A, 543B. The temperature sensor 550 can, for example, be overmolded by the material of the temperature sensing portion 543A, 543B and is therefore already embedded in the material of the temperature sensing portion 543A, 543B during the manufacture of the sealing element 54. In another embodiment, the sealing element 54 can be manufactured with a cavity formed in the particular temperature sensing portion 543A, 543B in order to insert the particular temperature sensor 550 into the associated cavity within the temperature sensing portion 543A, 543B after manufacturing the sealing element 54.

For an electrical connection, the temperature sensor 550 is connected to one or more sensor lines 551.

In order to conduct heat from the associated plug-in contact 51A, 51B to the particular temperature sensor assembly 55, the sealing element 54 as a whole or at least in the region of the particular second sealing portion 541A, 541B and the temperature sensing portion 543A, 543B is formed from a material with good thermal conductivity, in particular a silicone material, in which, for example, a ceramic filler such as aluminum oxide, aluminum nitrite, or boron nitrite can be embedded to improve the thermal conductivity.

On the one hand, the sealing element 54 seals a transition between the housing parts 503, 504 and also between the plug-in contacts 51A, 51B, 52 and the associated housing part 503 so that an interior of the housing 50 is sealed moisture-tight, and no moisture can penetrate into the housing 50 from the outside. The sealing element 54 also couples a temperature sensor assembly 55 to an associated plug-in contact 51A, 51B so that heat is conducted via the sealing element 54 for the purpose of temperature measurement at the plug-in contacts 51A, 51B.

The sealing element 54 is made of an electrically insulating material and therefore also provides electrical insulation between the particular temperature sensor assembly 55 and the associated plug-in contact 51A, 51B.

The concept upon which the invention is based is not limited to the exemplary embodiments described above, but can also be implemented in another manner.

A contact assembly of the described type can, for example, be part of a plug-in connector part in the form of a charging socket on the side of an electric vehicle. However, such a contact assembly can also be part of a plug-in connector part in the form of a charging plug on a charging cable.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Charging station
2 Charging cable
200, 201 End
3 Charging plug
30 Housing
300, 301 Plug section
31 Mating contact element
4 Vehicle
5 Charging socket
50 Housing
500, 501 Plug-in portion (receiving socket)
502 Rear cover
503, 504 Housing part
505A, 505B Receiving dome
506A, 506B Housing portion
507 Receiving dome
508, 509 Edge portion
51A, 51B Plug-in contact
510 Contact portion
511 Shaft portion
512 End
52 Contact elements
53A, 53B Load line
54 Sealing element
540 Sealing portion
541A, 541B Sealing portion
542A, 542B Connecting portion
543A, 543B Temperature sensing portion
544 Sealing portion
545 Connecting portion
55 Temperature sensor assembly
550 Temperature sensor
551 Sensor line
552 Circuit board
E Insertion direction
L Longitudinal axis

1. A plug-in connector part for a charging system for charging an electric vehicle, comprising:
a first housing part forming a plug-in portion for plugging into a mating plug-in connector part;
a second housing part connected to the first housing part;
at least one plug-in contact, arranged on the first housing part, configured for electrical contact with a mating contact element of the mating plug-in connector part;
a sealing element having a first sealing portion which seals-configured to seal a transition between the first housing part and the second housing part moisture-tight; and
a temperature sensor assembly comprising a temperature sensor,
wherein the sealing element has a second sealing portion, connected to the first sealing portion, configured to moisture-tight seal a transition between the first housing part and the at least one plug-in contact, and
wherein the temperature sensor is arranged on the sealing element so as to measure heating at the at least one plug-in contact.

2. The plug-in connector part of claim 1, wherein the sealing element comprises soft elastic material comprising a rubber material or a silicone material.

3. The plug-in connector part of claim 1, wherein the sealing element comprises an elastic plastic material containing a ceramic filler.

4. The plug-in connector part of claim 1, wherein the first sealing portion is arranged between a first edge portion of the first housing part and a second edge portion of the second housing part so as to moisture-tight seal the transition between the first housing part and the second housing part.

5. The plug-in connector part of claim 4, wherein the first sealing portion is circumferentially closed along an extension line along which the first edge portion and the second edge portion are placed on one another with an interposition of the first sealing portion.

6. The plug-in connector part of claim 1, wherein the at least one plug-in contact has a shaft portion, extending along a longitudinal axis, around which the second sealing portion extends.

7. The plug-in connector part of claim 6, wherein the at least one plug-in contact extends along the longitudinal axis through the first housing part.

8. The plug-in connector part of claim 6, wherein the at least one plug-in contact is received in a receiving dome formed on the first housing part, and
wherein the second sealing portion, viewed radially to the longitudinal axis, is arranged between the shaft portion and the receiving dome.

9. The plug-in connector part of claim 1, wherein the second sealing portion is connected to the first sealing portion via a connecting portion.

10. The plug-in connector part of claim 1, wherein the temperature sensor is arranged in a region of the second sealing portion on the sealing element so as to measure heating at the at least one plug-in contact.

11. The plug-in connector part of claim 1, wherein the sealing element has a temperature sensing portion, connected to the second sealing portion, on which the temperature sensor is arranged.

12. The plug-in connector part of claim 1, wherein the temperature sensor is embedded in a material of the sealing element.

13. The plug-in connector part of claim 1, wherein the temperature sensor is arranged on a circuit board, which rests on the sealing element.

14. A charging system for charging an electric vehicle, comprising:
the plug-in connector part of claim 1.

15. The charging system of claim 14, wherein the plug-in connector part is comprises a charging socket arranged on the electric vehicle.
